(19) United States
(12) Patent Application Publication
(10) Pub. No.: US 2007/0225846 A1
(43) Pub. Date: Sep. 27, 2007

(54) DYNAMIC TRACKING OF COMPLIANCE WITH PARAMETER LIMITS IN COMPUTER-AIDED DESIGN MODELS

(76) Inventors: William E. Bogan, Lakeside, CA (US); Gary R. Smith, Gresham, OR (US); Xiaohu Wang, Marietta, GA (US)

Correspondence Address: PATTERSON & SHERIDAN, L.L.P., 3040 POST OAK BOULEVARD, SUITE 1500, HOUSTON, TX, 77056, US

(21) Appl. No.: 11/539,835

(22) Filed: Oct. 9, 2006

Related U.S. Application Data
(60) Provisional application No. 60/785,540, filed on Mar. 23, 2006.

(51) Int. Cl. G06F 19/00

(52) U.S. Cl. 700/97; 700/98

(57) ABSTRACT

A designer of a CAD model is automatically notified when parameter limits or tolerances are violated during the iterative design process. The efficiency in the design of a complex model is much improved from the automatic notification, because it enables the user to detect violations of parameter limits and tolerances as soon as they occur.

### CROSS-REFERENCE TO RELATED APPLICATIONS

This application claims the benefit of U.S. Provisional Patent Application Ser. No. 60/785,540, entitled “Autolimits and Bevel Gears Generator,” filed Mar. 23, 2006, the entire contents of which are incorporated by reference herein.

### BACKGROUND OF THE INVENTION

1. Field of the Invention

The present invention generally relates to computer-aided design and, more particularly, to a method for dynamically tracking compliance with parameter limits in computer-aided design models.

2. Description of the Related Art

The term computer-aided design (CAD) generally refers to a broad variety of computer-based tools used by architects, engineers, and other construction and design professionals. CAD applications may be used to construct computer models representing virtually any real-world construct. For example, CAD applications are frequently used to create two-dimensional (2D) and three-dimensional (3D) models of mechanical devices.

The process of creating 3D models, e.g., of mechanical devices, is an iterative one. The configuration of all elements that make up the 3D model typically takes substantial experimentation and investigation on the part of the designer. Most designs impose parameter limits on system elements. For example, a shaft may have a length restriction, or an angle between two contacting metal pieces may have an allowable limit. Some of these parameters are due to mechanical considerations, e.g., stress. Some may be due to a limitation on the availability or cost of parts. Some may be for aesthetic reasons. Some parameters may be inviolable, while others may be fuzzy.

A complex 3D model has many such parameters and it has been difficult and somewhat cumbersome to monitor these parameters with conventional CAD tools. During the iterative design process, the designer may in fact violate one of these parameters, but may not realize it until he or she has committed a substantial amount of additional design time.

### SUMMARY OF THE INVENTION

The present invention provides a method for automatically notifying the designer of a CAD model when a parameter of the CAD model is violated during the iterative design process, and a computer readable medium comprising instructions that cause a computing device to perform this method. With the present invention, the efficiency in the design of a complex model is much improved, because the automatic notification enables the user to detect violations of parameter limits and tolerances as soon as they occur.

According to an embodiment of the present invention, a computing device monitors parameters of a CAD model during an iterative design process for the CAD model and automatically notifies the user of any parameter violations through a graphical user interface (GUI). The method according to this embodiment includes the steps of receiving inputs that specify a parameter to be monitored and at least one boundary value for the parameter, comparing the value of the parameter with the boundary value as changes are made to the CAD model, and notifying the user through the GUI based on the comparison result. When the boundary value is a lower bound, the user is notified when the value of the parameter is less than or equal to the boundary value. When the boundary value is an upper bound, the user is notified when the value of the parameter is greater than or equal to the boundary value.

Boundary values may include a first upper bound and a second upper bound. In such a case, the user is notified through the GUI with a first symbol (e.g., triangle) having a first color (e.g., yellow) if the parameter value is between the first and second upper bounds and with a second symbol (e.g., square) having a second color (e.g., red) if the parameter value is greater than the second upper bound. The parameter that is monitored may include any of the following: length, angle, diameter, perimeter, area, volume, mass, and a distance between two surfaces.

Boundary values may also include a first lower bound and a second lower bound. In such a case, the user is notified through the GUI with a first symbol (e.g., triangle) having a first color (e.g., yellow) if the parameter value is between the first and second lower bounds and with a second symbol (e.g., square) having a second color (e.g., red) if the parameter value is less than the second lower bound.

According to another embodiment of the present invention, a user designs a CAD model through a GUI of a CAD program and receives notification through the GUI when a parameter of the CAD model is violated during the design. The method according to this embodiment includes the steps of specifying a parameter to be monitored and at least one boundary value for the parameter through the GUI, making changes to the CAD model through the GUI, and receiving a notification through the GUI based on the comparison result. When the boundary value is a lower bound, the user is notified when the value of the parameter is less than or equal to the boundary value. When the boundary value is an upper bound, the user is notified when the value of the parameter is greater than or equal to the boundary value.

The parameter to be monitored may be specified by positioning the cursor of a pointing device on top of a feature on the CAD model so that the feature becomes highlighted, and then clicking on an input button of the pointing device to confirm the highlighted feature as the parameter to be monitored. Also, if the cursor of the point device is positioned on top of a graphic corresponding to the parameter being monitored, the value of the parameter is displayed.

### BRIEF DESCRIPTION OF THE DRAWINGS

FIG. 1 is a conceptual block diagram of a computer system with which embodiments of the present invention can be practiced.

FIG. 2A is a sample sensor tool bar or panel.

FIGS. 2B-2D are sample sensor dialog boxes.

FIGS. 3A-3C illustrate the process for selecting inputs for a length sensor.

FIG. 4 illustrates changes in the input cursor when the input cursor is hovered on top of an edge or a face.

FIG. 5 is a sample sensor dialog box that has the boundary tab selected.

FIG. 6 is a sample dialog box for setting tolerances.

FIG. 7 is a sample sensor browser panel.

FIG. 8A illustrates components of a sensor display in the graphics region.

FIGS. 8B-8J illustrate changes in the sensor display when the sensor glyph is repositioned.

FIGS. 9A-9B are sample tool tips displays.

FIG. 9C is a sample dialog box for selecting sensor parameters to be displayed in a tool tips display.

FIG. 10 is a flow diagram that illustrates the steps carried out to monitor a parameter's compliance with user-set limits.

### DETAILED DESCRIPTION

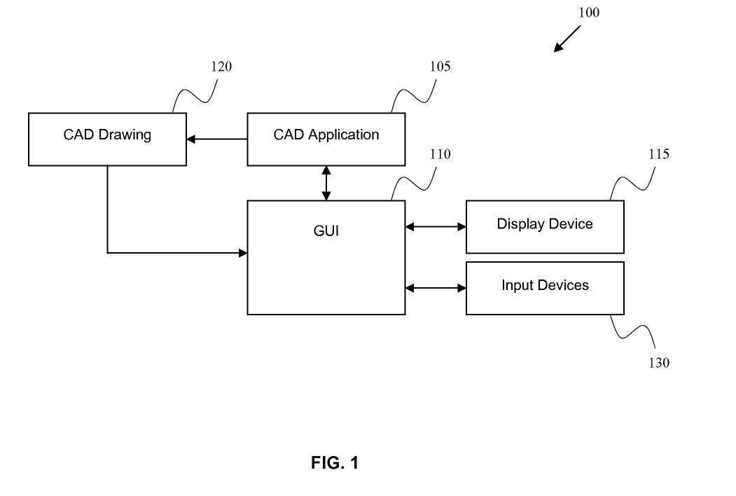

FIG. 1 is a conceptual block diagram of a computer system 100 with which embodiments of the present invention can be practiced. The components of the computer system 100 illustrated in FIG. 1 include CAD application 105, graphical user interface (GUI) 110, CAD drawing 120, user input devices 130, and a display device 115. CAD application 105 is a software application that is stored in memory and executed by the processor of the computer system 100. It includes software program routines or instructions that allow a user interacting with GUI 110 to create, view, modify and save CAD drawing or model 120. In the examples provided herein, the CAD application 105 is the Autodesk® Inventor software application program and associated utilities. Typically, user input devices 130 include a mouse and a keyboard, and display device 115 includes a CRT monitor or LCD display.

The present invention provides GUI tools included in CAD application 105 for specifying parameters to be monitored, boundary values for the parameters, and notifying the user of any violation of the parameter boundary values as the user is creating or editing a CAD model 120 with CAD application 105. Parameters that can be monitored include any of the following: length, distance, angle, perimeter, area, volume, void/cavity, mass, diameter, minimum distance, and center of gravity. CAD application 105 creates a sensor (in the form of a software object) for each of these parameters. When an assembly depicting CAD model 120 is opened, only the sensors residing in the top level assembly will be loaded. When the user opens a subassembly or part document for editing, the sensors in the edit target document are loaded and enabled and the sensors in the top level assembly are disabled.

Three categories of sensors are provided. They include dimension sensors, area-perimeter sensors, and physical properties sensors. The length, angle, diameter, distance, and minimum distance sensors are dimensional sensors. The perimeter and area sensors are area-perimeter sensors. The volume, mass and center of gravity sensors are physical properties sensors.

The length sensor monitors the length of selected features in 2D or 3D models. In 2D models, it monitors the length of a selected line, arc, circle, ellipse, or spline. In 3D models, it monitors the length of a selected edge, which may be straight or curved (e.g., arc, spline, elliptical, etc.). One or more features may be selected as input to the length sensor.

The angle sensor monitors the angle between selected inputs, e.g., between points, lines, faces, work points, work axes, and work planes in 2D and 3D spaces. Where the initial input lines or planes are parallel, the angle measured will be zero degrees. If the lines are later “driven” to a condition reversing the vector the angle should read 180 degrees and not zero degrees. One or more angles may be selected as input to the angle sensor.

The diameter sensor monitors the diameter of a selected input. The selected input in 2D models may be sketch circles and arcs. The selected input in 3D models may be arc edges, circular edges, and constant curvature faces (e.g., cylinder, cylindrical section, sphere, or spherical section). One or more inputs may be selected as input to the diameter sensor.

The distance sensor monitors the distance between selected inputs. The valid inputs may be two planar faces or a planar face and a curved face. In the former case, the minimum distance between the two planar faces is monitored. In the latter case, the minimum distance to the feature axis of the curved face is monitored. The minimum distance sensor monitors the minimum distance between selected inputs. The valid inputs may be vertex, edge, face, part, and sub-assembly.

The perimeter sensor monitors the length of edges enclosing a face. One set of edges that enclose a face is referred to as a geometry loop. One or more geometry loops may be selected as input to the perimeter sensor. The area sensor monitors the area of the selected face. One or more faces can be selected as input to the area sensor.

The volume sensor monitors the volume of a selected input. Volume is often measured for individual components, sub assemblies, and final assemblies. Therefore, the user is able to select any level of component as input to the volume sensor. The mass sensor monitors the mass of a selected input. Mass is often measured for individual components, sub assemblies, and final assemblies. Therefore, the user is able to select any level of component as input to the mass sensor. The center of gravity sensor monitors the center of gravity position in 3D space within a selected model.

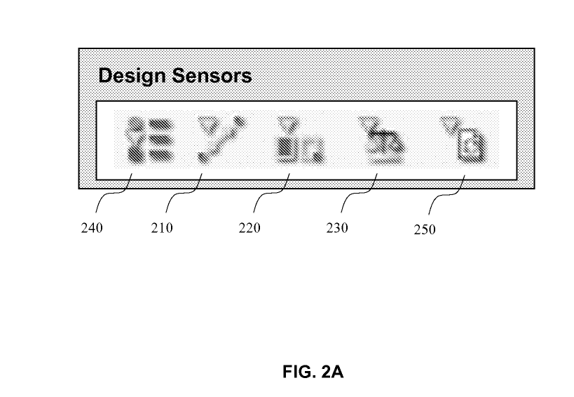

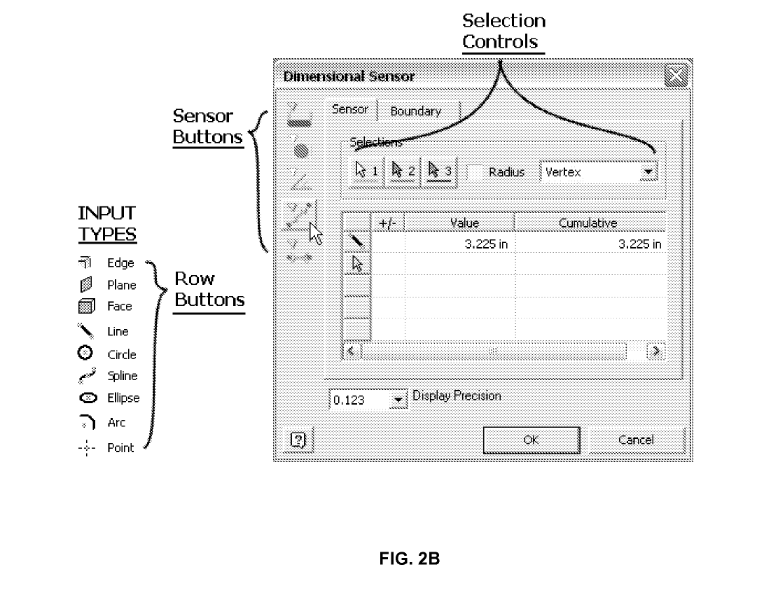

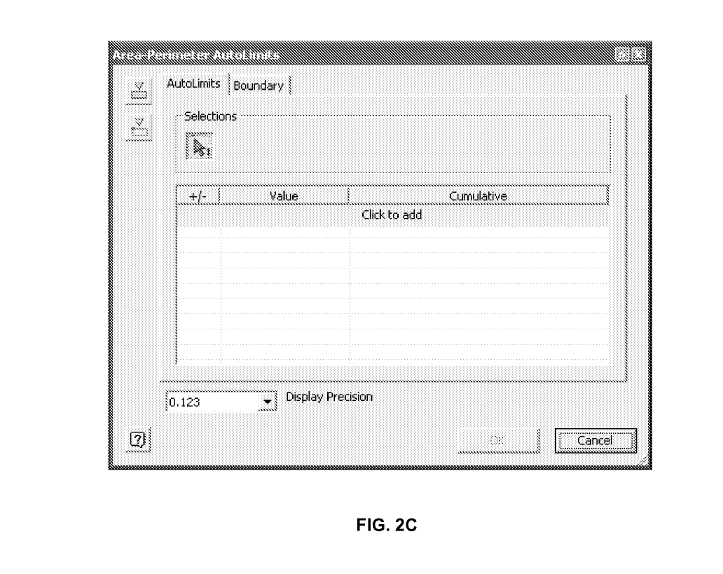

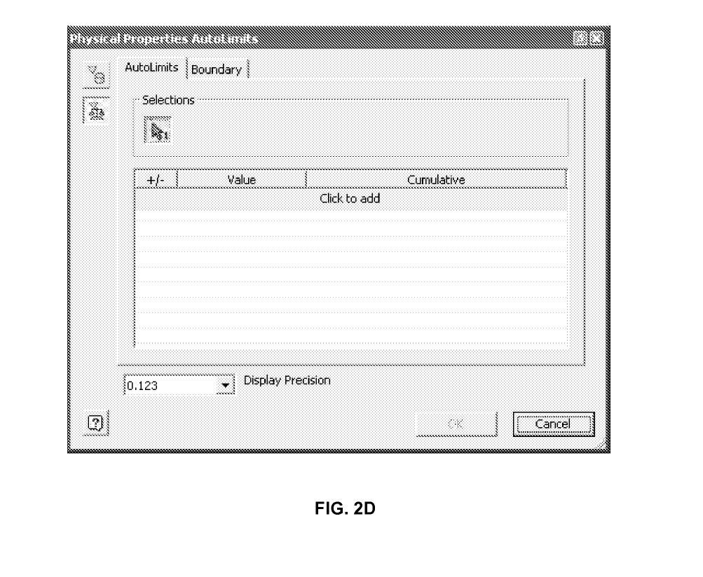

The three sensor categories are presented to the user using a GUI tool bar or panel like the one shown in FIG. 2A. The selection of a dimension sensor icon 210 will open a dialog box for dimensional sensors as shown in FIG. 2B. The selection of area-perimeter sensor icon 220 will open a dialog box for area-perimeter sensors as shown in FIG. 2C. The selection of physical properties sensor icon 230 will open a dialog box for physical properties sensors as shown in FIG. 2D. When the user selects an already created sensor for edit, the dialog box corresponding to that sensor is also opened.

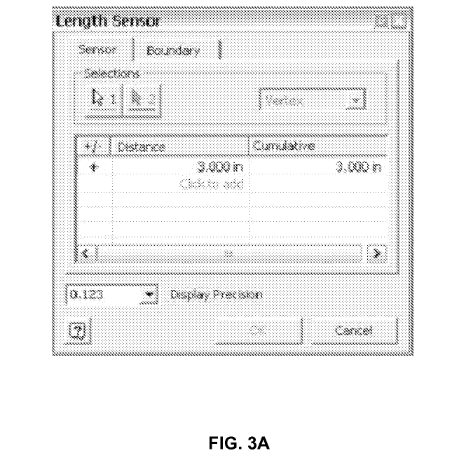

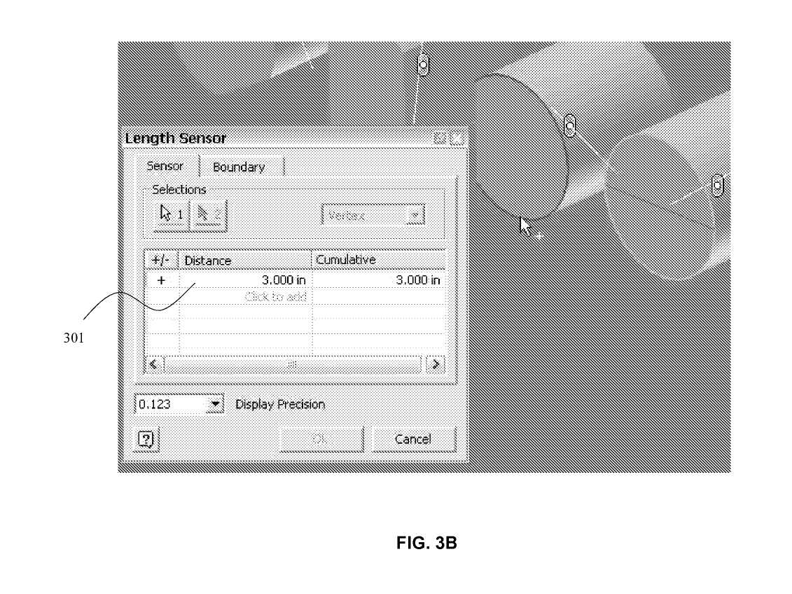

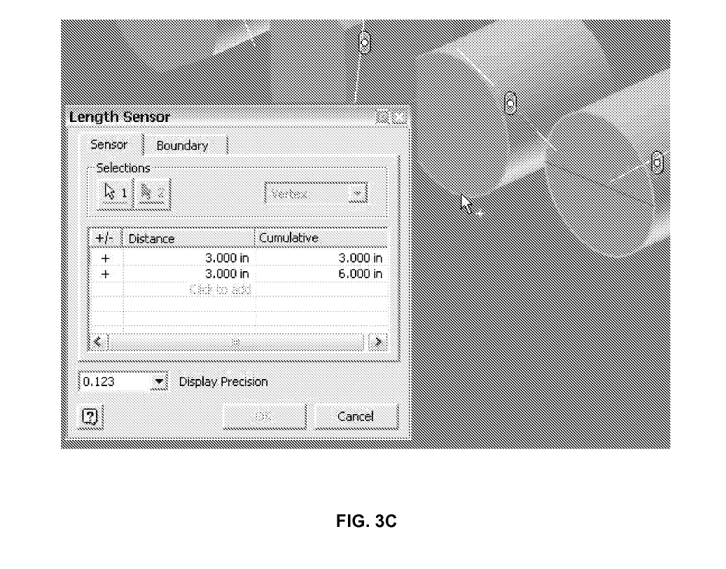

The dialog box for dimensional sensors includes selectable icons 211 corresponding to length, angle, diameter, distance, and minimum distance sensors. FIG. 3A illustrates the dialog box for a length sensor. FIGS. 3B and 3C illustrate updates to the length sensor dialog box as inputs are selected for the length sensor. In FIG. 3B, the user has already made the first input 301 and is pausing the cursor over a feature in the drawing to select the second input. When CAD application 105 detects that the cursor is positioned over a valid feature for a length sensor, the feature highlights. When the user clicks on that feature, the dialog box updates as shown in FIG. 3C and the user can make another input selection.

Because an input cursor position can coincide with a point, a line, or a face of CAD model 120 at the same time, CAD application 105 gives selection priority to a point over a line and a face, and to a line over a face. Also, an input cursor is deemed to be positioned over a point, a line, or a face if it is within X number of pixels (e.g., 5 pixels) from that feature.

The user may select inputs for dimensional sensors without affirmatively selecting a particular type. When the user does this, a default selection of a dimensional sensor is made by CAD application 105 depending on the user's first input. When a line, ellipse, spline or edge is the selected input, the length sensor is the default. When a circle or an arc is the selected input, the diameter sensor is the default. The user can change the sensor selection using the context menu, which can be brought up by right-clicking on the user's input device, or by selecting additional inputs. When a second input is made, CAD application 105 may change the default sensor selection.

The valid inputs for dimensional sensors are listed in the table below and the bold text shows the default sensor selection that is made by CAD application 105 when two input selections is made. When two points are selected as the first two input selections, the distance sensor is the default. When a third point is selected as the third input selection, the default changes to the angle sensor. In those cases where the angle sensor or the distance sensor may be the default sensor, the angle sensor is the default sensor if the input selections are not parallel and the distance sensor is the default sensor if the inputs selections are parallel.

| | | | | | Ellipse- | | | |
|---|---|---|---|---|---|---|---|---|
| Inputs | Point | Line | Circle | Arc | Spline | Edge | Plane | Face |
| Point | Distance | Distance | Distance | Distance | Distance | Distance | Distance | Distance |
| | Angle | Min. Dist. | Min. Dist. | Min. Dist. | Min. Dist. | Min. Dist. | Min. Dist. | Min. Dist. |
| | Min. Dist. | | | | | | | |
| Line | Noted | Angle or | Distance | Distance | Distance | Angle³ | Angle³ | Angle³ |
| | | Distance | Min. Dist. | Min. Dist. | Min. Dist. | Distance | Distance | Distance |
| | | Min. Dist. | | | | Min. Dist. | Min. Dist. | Min. Dist. |
| Circle | Noted | Noted | Distance | Distance | Distance | Distance | Distance | Distance |
| | | | Min. Dist. | Min. Dist. | Min. Dist. | Min. Dist. | Min. Dist. | Min. Dist. |
| Arc | Noted | Noted | Noted | Distance | Distance | Distance | Distance | Distance |
| | | | | Min. Dist. | Min. Dist. | Min. Dist. | Min. Dist. | Min. Dist. |
| Ellipse- | Noted | Noted | Noted | Noted | Distance | Distance | Distance | Distance |
| Spline | | | | | Min. Dist. | Min. Dist. | Min. Dist. | Min. Dist. |
| Edge | Noted | Noted | Noted | Noted | Noted | Angle or | Angle or | Distance |
| | | | | | | Distance | Distance | Min. Dist. |
| | | | | | | Min. Dist. | Min. Dist. | |
| Plane | Noted | Noted | Noted | Noted | Noted | Noted | Angle or | Angle or |
| | | | | | | | Distance | Distance |
| | | | | | | | Min. Dist. | Min. Dist. |
| Face | Noted | Noted | Noted | Noted | Noted | Noted | Noted | Angle or |
| | | | | | | | | Distance |
| | | | | | | | | Min. Dist. |

In addition, when a user hovers over an input feature, the input feature highlights and the input cursor changes to indicate to the user the default sensor selection that would be made by CAD application 105 if the user selected this input feature. Thus, the input cursor may be changed to a length cursor, an angle cursor, a diameter cursor, and a distance cursor.

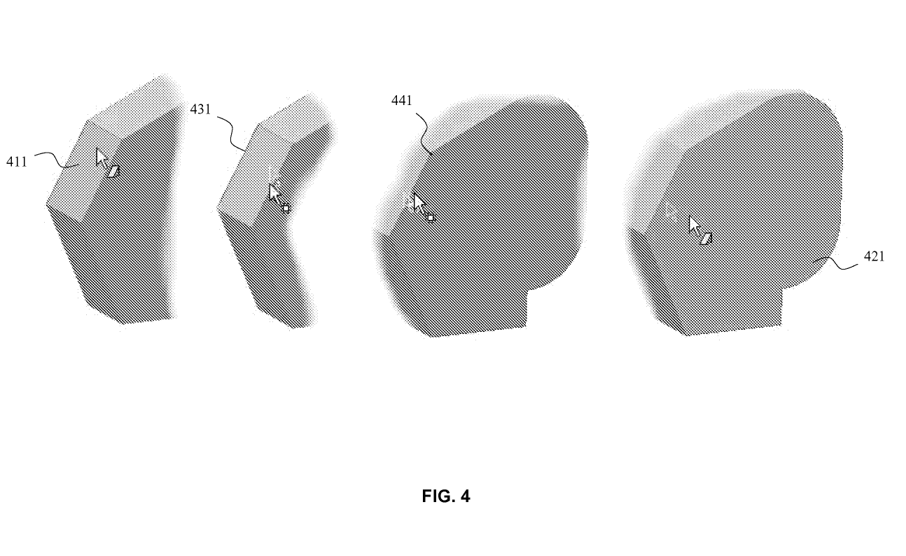

When the dialog box for the area-perimeter sensor appears (FIG. 2C), there is no determination made by CAD application 105 as to whether the sensor is an area sensor or a perimeter sensor. The determination is made based upon the first input selection. As shown in FIG. 4, if the user pauses the input cursor over a face, the edges of the face 411, 421 are highlighted and the input cursor changes to an area cursor. If this face is selected as the input, then CAD application 105 determines that the area-perimeter sensor is an area sensor. On the other hand, if the user pauses the input cursor over an edge, the loop 431, 441 for the nearest face is highlighted and the input cursor changes to a perimeter cursor. If this edge is selected as the input, then CAD application 105 determines that the area-perimeter sensor is a perimeter sensor.

When the input cursor is within the location tolerance of an edge, all edges of the nearest face highlight and the perimeter cursor and sensor is previewed. When the cursor is moved away from the edge, toward the interior of the face, the area cursor and sensor previews. After the user clicks to accept the previewed sensor, subsequent selections are limited to that particular sensor. For example, after the perimeter sensor has been accepted, from that point on, only the face perimeters highlight and are selectable regardless of the location within a face the input cursor is positioned.

When the dialog box for the physical properties sensor appears (FIG. 2D), CAD application 105 automatically selects the mass sensor as the default sensor selection. The user can change the sensor selection using the context menu, which can be brought up by right-clicking on the user's input device.

Some sensors permit more than two input selections. The third one is enabled under the following circumstances. Where the first two input selections are points, the third input selection can be a third point for angle measurement. Where the first two input selections are a point and line, the third input selection can be a vertex for angle measurement between the vector connecting the two points and the line.

The sensor dialog boxes for the different types of sensors are the same except that some sensors require more than one input. All sensor dialog boxes include a table that displays the value of the selected input and a cumulative column that presents the cumulative results of multiple input selections. The cumulative results may be the result of adding or subtracting the values of the selected inputs to and from the cumulative value. The input value is added to the cumulative value if a “+” appears in the +/− column. The input value is subtracted from the cumulative value if a “−” appears in the +/− column.

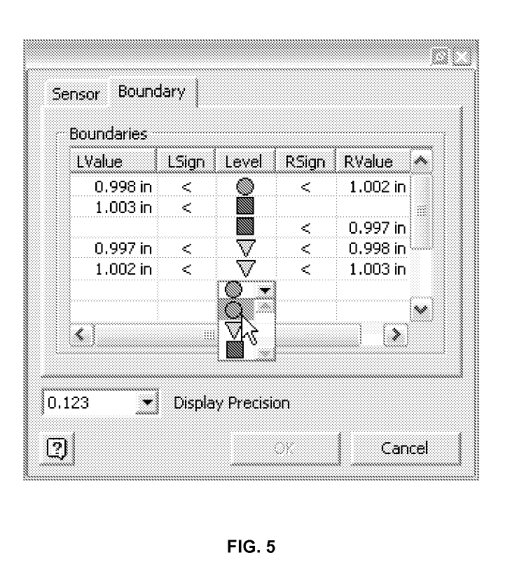

Tolerances or boundary values can be set using the boundary tab of the sensor dialog box. FIG. 5 illustrates a sensor dialog box with the boundary tab selected. The green circle denotes a range of values that are within tolerance. The amber triangle zone denotes a range of values that are at tolerance. The red square zone denotes a range of values that exceed tolerance. The green, yellow and red indicators are purposely designed as a circle, triangle and square, respectively, so as to enable quick recognition by anyone whose vision is color-deficient. The boundary fields are populated one click at a time per row and always incremented higher than the previous input in the following manner. First, the user clicks on an open row to populate the boundary value. The first value is the sensor value (green icon) with assigned tolerances to either side of it in the LValue and RValue fields. A second click will populate the next row with the “+” amber zone boundary value. If the user holds down the CTRL key with the second click, the “−” amber zone boundary value is used. If the user wants a full range of tolerances, upper and lower for the sensor, the user may hold down the ALT key while clicking on an open row. This user action automatically populates all five rows of the boundary zones.

The assigned tolerances are set using the sensor parameters dialog box shown in FIG. 6. This dialog box appears when the user selects the sensor parameters icon 240 from the tool bar or panel shown in FIG. 2A. The user is able to specify whether the tolerance boundary is a percentage of the nominal value, or a fixed value on either side of the nominal value. When using percentages, these are percent values in relation to the sensor “green” value. If the method is “+/−,” the user specifies the LValue and RValue that will be subtracted or added to the nominal value. The value is consistently applied to all zones.

The user may also use a part model tolerance as the assigned tolerance. If this option is selected, whenever a sensor is applied to a parameter value that has part model tolerancing, that tolerance defines the LValue and RValue for the green zone. The user can then fine tune the result.

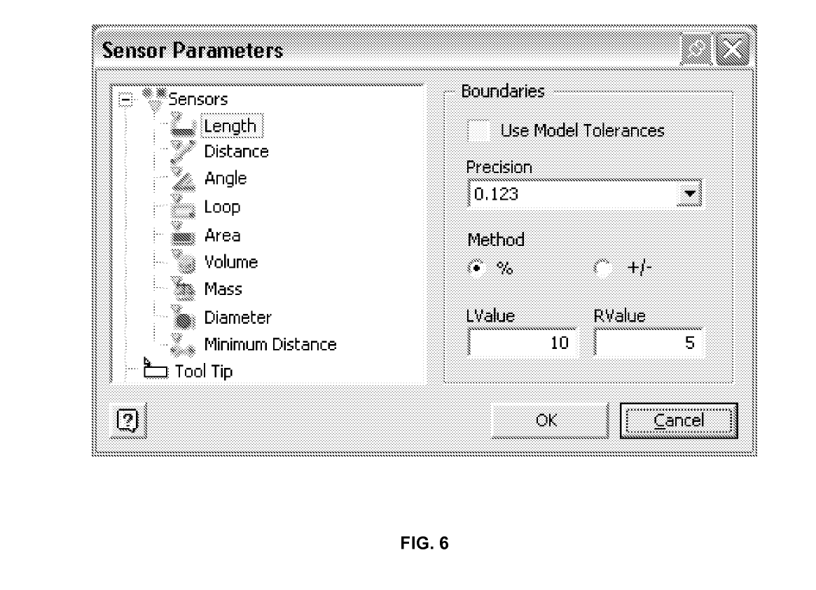

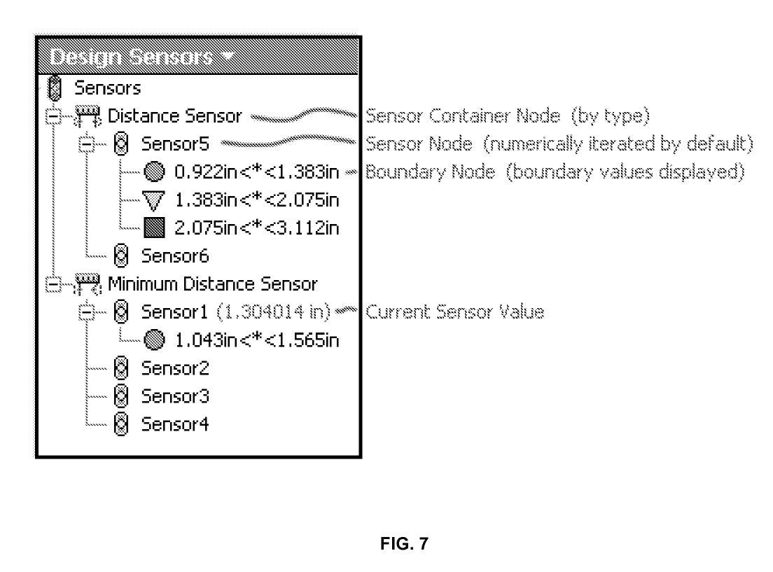

The individually created sensors can be presented to the user by changing the browser panel to display sensors. When the browser panel is changed to display sensors, the tool panel also changes to display the sensor tools shown in FIG. 2A. The browser panel for sensors can be displayed while within a part, sheet metal, weldment, or assembly environments of CAD model 120. A sample sensor browser is illustrated in FIG. 7. The sensor browser displays a node for each sensor that displays the sensor status as well as threshold values for the sensor. A sensor whose current value is within tolerance displays a green circle as its status. A sensor whose current value exceeds the first threshold but not the second threshold displays an amber triangle as its status. A sensor whose current value exceeds both the first threshold and the second threshold displays a red square as its status. The user may specify input selections directly from the sensor browser, e.g., when placing sensors for mass or volume on top-level or sub-assemblies since it would be unreasonable for the user to have to select individual components making up these, as they can easily number into the hundreds of components.

Within the browser panel, the user is able to create named groups of sensors and designate group behavior. The default group named “Sensors” already exists, when the user changes to the sensor browser. The group is initially empty by default. The user then populates the group by creating sensors. The user can move sensors into a group by dragging and dropping instances of existing sensors into the group. The user can also copy sensors into a group by dragging and dropping instances of existing sensors into the group while pressing the CTRL key. Sensor groups can be deleted. If a sensor group is deleted, the user will be warned that the action will delete all sensors in the group. The user is asked to confirm deletion. The action of deleting sensors is undo-able. The user is also permitted to disable or enable all sensors contained in a group as well as jointly control their visibility using a context menu, which can be brought up by right-clicking on the user's input device.

Within the different environments of CAD model 120, sensors are visible only at the level at which they are created. Thus, if editing a top level assembly, only sensors created at the top level would be shown. Sensors that are deeper in the assembly would not be shown until the model is edited at that level. The user is, however, able to select a sensor and promote it up the assembly hierarchy to the top level or demote it in the other direction. A promoted sensor maintains the original input object. Promoted sensors update according to the input conditions at that level. Thus, a promoted sensor may have been in the green circle zone before promotion, and in another zone after promotion. The sensor should update and exhibit the appropriate behavior for that zone. If a promoted sensor loses one or more inputs due to changes at that level, the sensor will become sick or invalid. The user is able to delete or modify the sensor inputs to resolve sickness. A sick sensor is represented by coloring the sick object magenta.

After sensors are created and their boundary values are specified, CAD application 105 continuously monitors these sensors during the iterative process of developing CAD model 120. The user is able to control the visibility of the sensors in the graphic display. The user may set all sensors to be visible in the graphic display regardless of their boundary conditions or set them to visible in the graphic display only when the amber triangle or red square thresholds are reached or only when the red square thresholds are reached. The default setting is for sensors that are in the green circle zone to not be visible and the sensors in the other zones to be visible.

The user has the option of checking ON/OFF the real-time refresh for sensors. Where performance is a concern, the user should turn OFF real-time refresh and manually refresh the sensors as needed by clicking on the refresh icon 250 in the tool bar or panel shown in FIG. 2A.

When the input cursor hovers over a sensor in either the sensor browser or the graphics region, the sensor and the input features selected for that sensor should highlight in both the sensor browser and the graphics region. Whenever a sensor is edited, the sensor in both the browser and the graphics region should highlight upon selection.

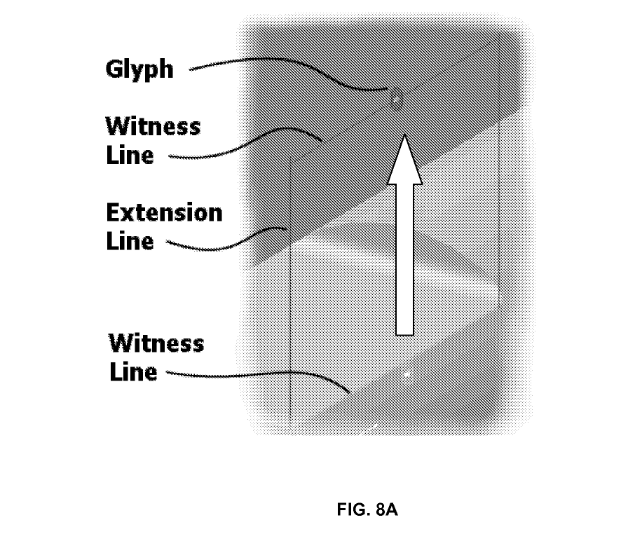

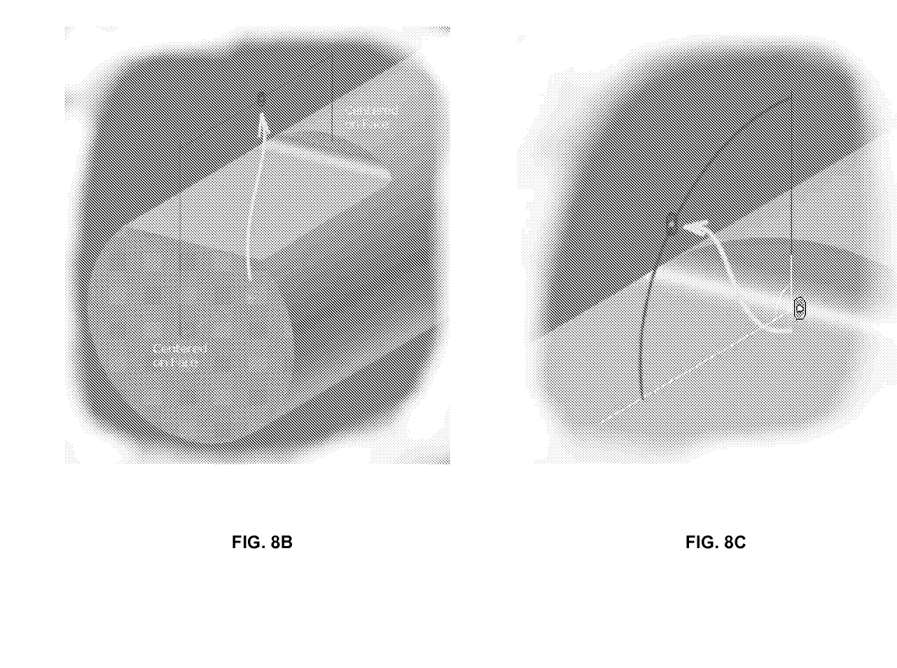

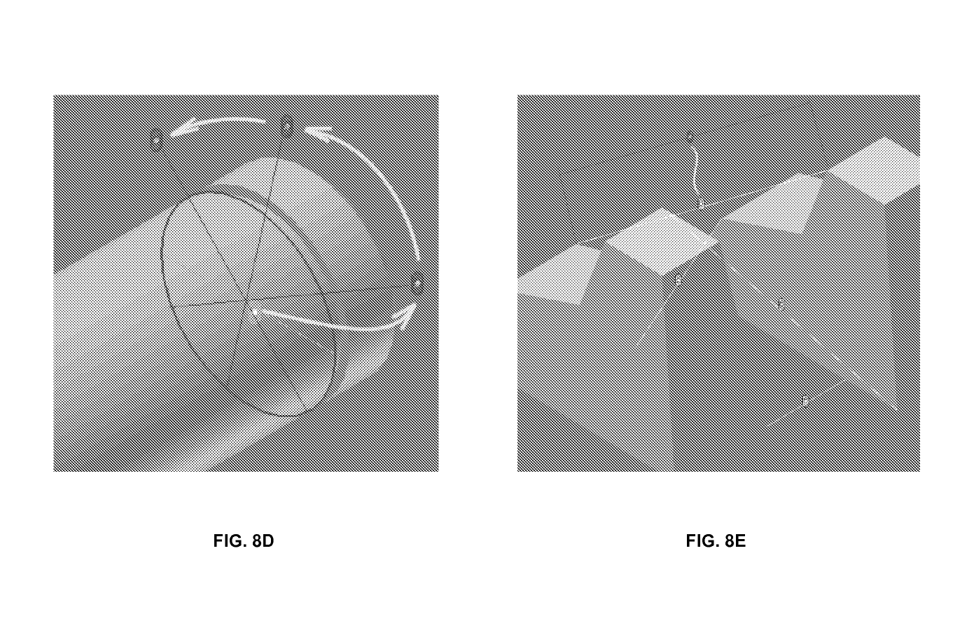

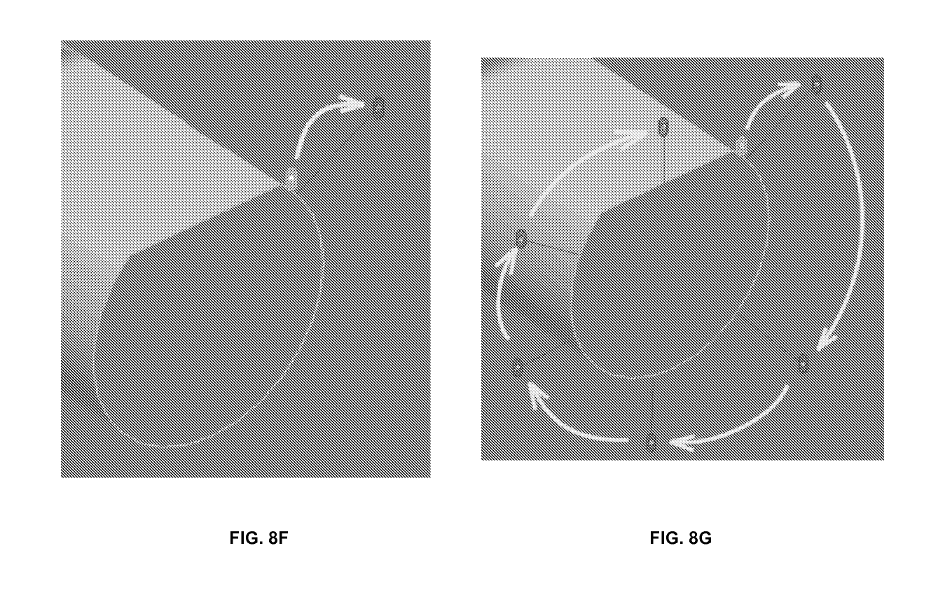

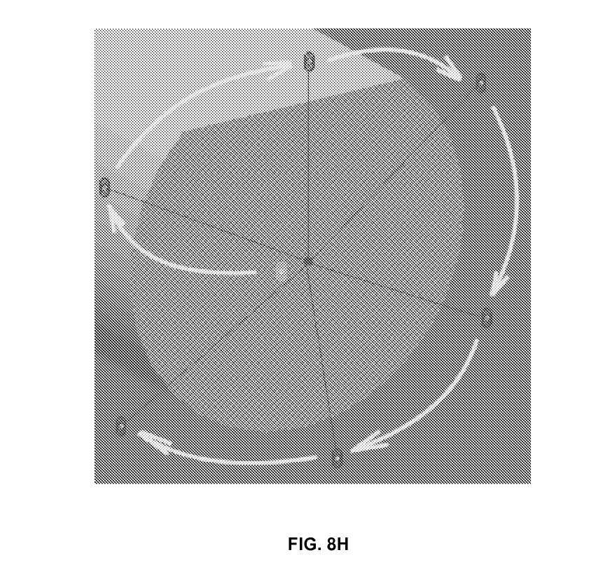

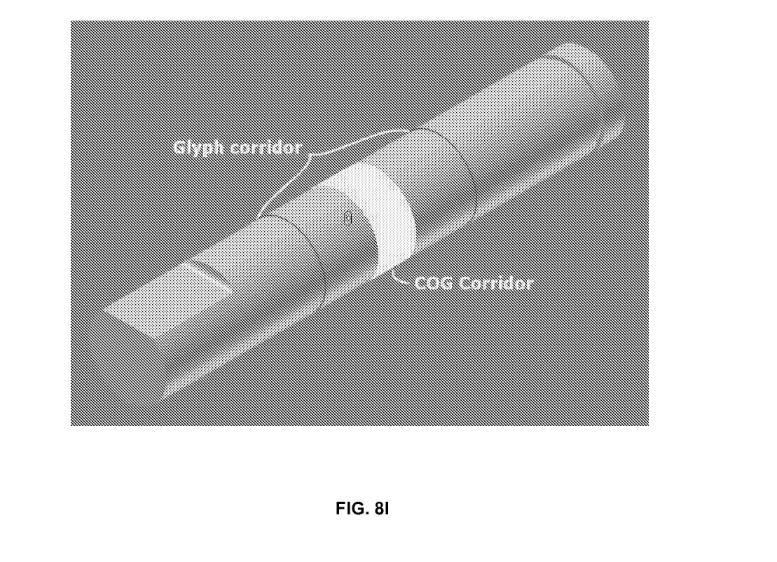

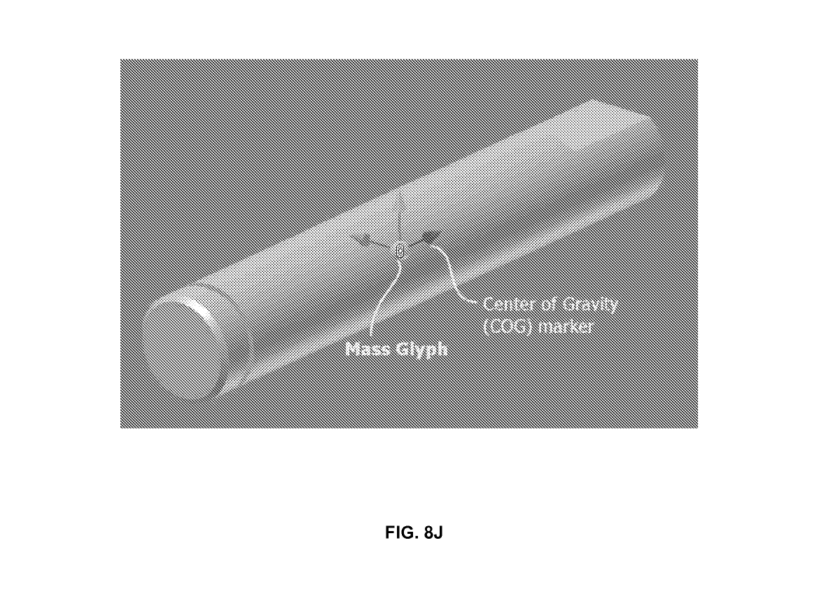

FIGS. 8A-8J illustrate sensors that are displayed on top of the graphic display and show how each of the sensors can be repositioned within the graphic display by grabbing the sensor with an input pointing device and dragging it to a desired position. Repositioning may be desired so that the sensor is more visible within the graphic display. The sensor graphic is a glyph. The glyph is a 2D element that is attached to 3D locations. A sample glyph is shown in FIG. 8A in two positions. The bottom position is the initial position. The top position is the new position. FIG. 8A also shows extension lines and witness lines for the two glyph positions. The following examples provide fundamental concepts for guiding the development of the repositioning algorithms for the sensors:
Point-Point—2 points define X Vector for CS [What is CS?]. Extension lines are perpendicular to X vector in a rational plane.
Point-Line—Line endpoints and point establish local XZ plane. Extension lines are in local XY or local YZ plane.
Point-Circle—Circle plane defines local XY plane. Local XZ plane is perpendicular to local XY through point. Extension lines are in local XY or local YZ plane.
Point-Arc—Arc plane defines local XY plane. Local XZ plane is perpendicular to local XY through point. Extension lines are in local XY or local YZ plane.
Point-Ellipse—Ellipse plane defines local XY plane. Local XZ plane is perpendicular to local XY through point. Extension lines are in local XY or local YZ plane.
Point-Spline—Spline endpoints and point define local XZ plane. Extension lines are in local XY or local YZ plane.
Point-Edge—Edge endpoints and point define local XZ plane. Extension lines are in local XY or local YZ plane.
Point-Plane—Plane signifies the local XY plane. Local XZ plane is perpendicular to local XY through point. Extension lines are in local XY or local YZ plane.
Point-Planar Face—Face signifies the local XY plane. Local XZ plane is perpendicular to local XY through point. Extension lines are in local XY or local YZ plane.
Point-Non Planar Face—Vector normal to plane passing through point defines X Vector for CS. Extension lines are perpendicular to X vector in a rational plane.
Line-Line—The vector between midpoints defines the local X vector. The X vector and the first input establish local XZ plane. Extension lines are in local XY or local YZ plane.
Line-Circle—Circle plane defines local XY plane. Local XZ plane is perpendicular to local XY through line mid-point. Extension lines are in local XY or local YZ plane.

Line-Arc—Arc plane defines local XY plane. Local XZ plane is perpendicular to local XY through line mid-point. Extension lines are in local XY or local YZ plane.
Line-Ellipse—Ellipse plane defines local XY plane. Local XZ plane is perpendicular to local XY through line mid-point. Extension lines are in local XY or local YZ plane.

For repositioning of the length sensor illustrated in FIG. 8A, the witness line remains and extension lines are added, and the extension lines extend perpendicular to wherever the user drags the sensor. If the glyph is dragged back over the edge and released, the original position is restored. The sensor glyph will not pull away from the witness or extension lines.

For repositioning of the distance sensor illustrated in FIG. 8B, the witness line remains and extension lines are added. The extension lines extend parallel to the input face, and extend from the center of the face to just beyond the witness lines. If the glyph is dragged onto an input face and released, the original position is restored. The sensor glyph will not pull away from the witness or extension lines.

For repositioning of the angle sensor illustrated in FIG. 8C, the witness line grows to meet the extension lines. The extension lines extend just beyond the witness line, and the plane on which the extension is drawn is perpendicular to the input planes. If the glyph is dragged back over the center of the angle and released, the original position is restored. The sensor glyph will not pull away from the witness or extension lines.

FIG. 8D illustrates the repositioning of the diameter sensor. As shown in FIG. 8D, the diameter glyph is initially placed at the component's center of the diameter with witness lines extending to the edge. The sensor graphics are planar to the edge. Upon repositioning, a leader line is attached to the glyph and to the circular edge. The leader line will emanate from the witness line. If the glyph is dragged back over the edge and released, the original position is restored. The sensor glyph will not pull away from the leader line.

FIG. 8E illustrates the repositioning of the minimum distance sensor. Where the inputs are planar, the sensor graphics will similarly be constructed in a planar fashion. The sensor inputs dictate the logical plane that the sensor graphics are built on.

For repositioning of the perimeter sensor illustrated in FIGS. 8F and 8G, a leader line attached to the glyph and to the loop is created. The leader line will be perpendicular to the loop edge it is associated with and parallel with the face or the primary face making up the loop. If possible, the leader line will be represented as the shortest distance between the nearest loop edge and the glyph. If the glyph is dragged back over point of attachment to the loop and released, the leader line is removed. The sensor glyph will not pull away from the leader line.

FIG. 8H illustrates the repositioning of the area sensor. As shown in FIG. 8H, a leader line is attached to the glyph and to a small dot at the approximated center of the area. Upon repositioning, the leader line will emanate from the small dot. The leader line lies on a plane defined by the face, if planar. If circular, then the sensor should lie tangent to the point approximating the center of the area of the face. For example, a 2-inch diameter shaft that is 6 inches long would get an area sensor that is located 1 inch from the axis of the cylinder and 3 inches from the end. Because the cylinder is whole, any location that is tangent to the face is acceptable. Where the cylinder face is not whole, an attempt at locating the tangency nearest the face center is desirable. The leader line will always be represented as the shortest distance between the dot and the glyph. If the glyph is dragged back over the dot and released, the original position is restored. The sensor glyph will not pull away from the leader line.

FIG. 8I illustrates the repositioning of the volume sensor. As shown in FIG. 8I, the volume glyph is initially placed anywhere inside the glyph corridor, which is approximately the center ⅓ of the component, but not inside the center of gravity corridor (center 5%) to prevent occlusion of a mass glyph. Upon repositioning, a leader line is attached to the glyph and to a small dot at the glyph origin. The leader line will emanate from the small dot. The leader will always be represented as the shortest distance between the dot and the glyph. If the glyph is dragged back over the glyph corridor and released, the original position is restored. The sensor glyph will not pull away from the leader line.

FIG. 8J illustrates the repositioning of the mass sensor. As shown in FIG. 8J, the mass glyph is initially placed at the component's center of gravity. Upon repositioning, a leader line is attached to the glyph and to a small dot at the COG. The leader line will emanate from the dot. The leader will always be represented as the shortest distance between the dot and the glyph. If the glyph is dragged back over the dot and released, the original position is restored. The sensor glyph will not pull away from the leader line.

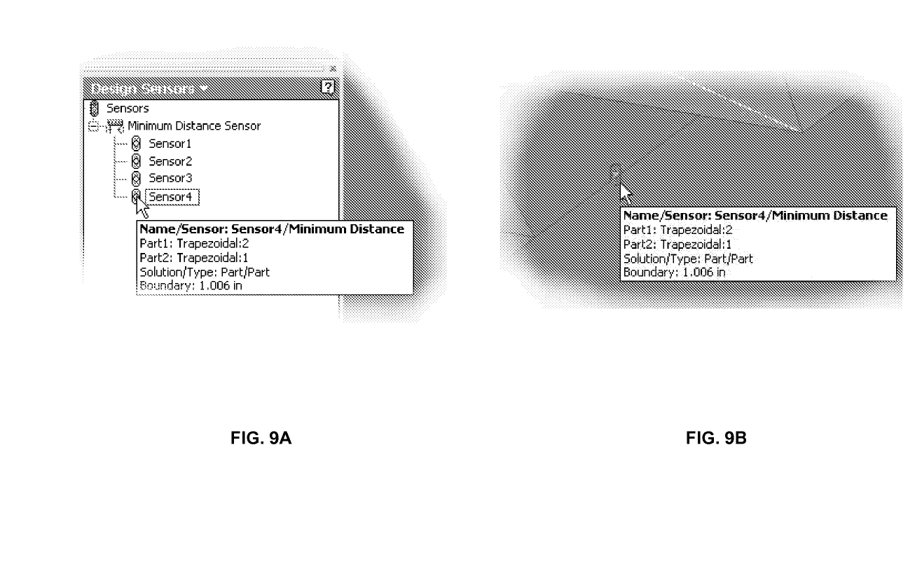

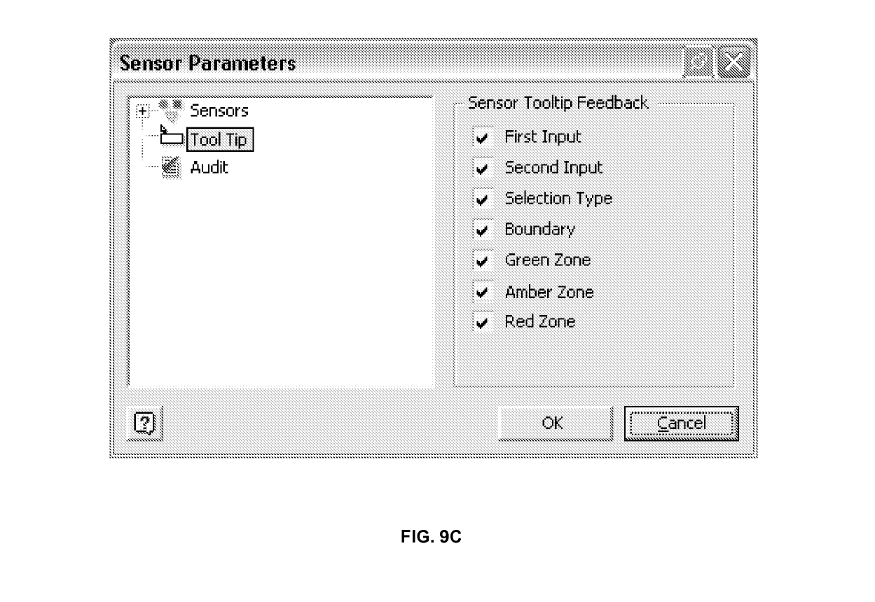

FIGS. 9A and 9B illustrate tool tips that are displayed to the user, when the user positions an input cursor on top of a sensor in the sensor browser or a sensor glyph in the graphics region. The tool tip may contain any of the following information: sensor name, sensor type, sensor inputs, selection types, current value of the sensor, and the value ranges for the green zone, amber zone, and the red zone. The tool tip settings are specified using a dialog box such as the one shown in FIG. 9C. The user is able to uncheck those values the user wishes not to see displayed in the tool tip. The default has all options checked.

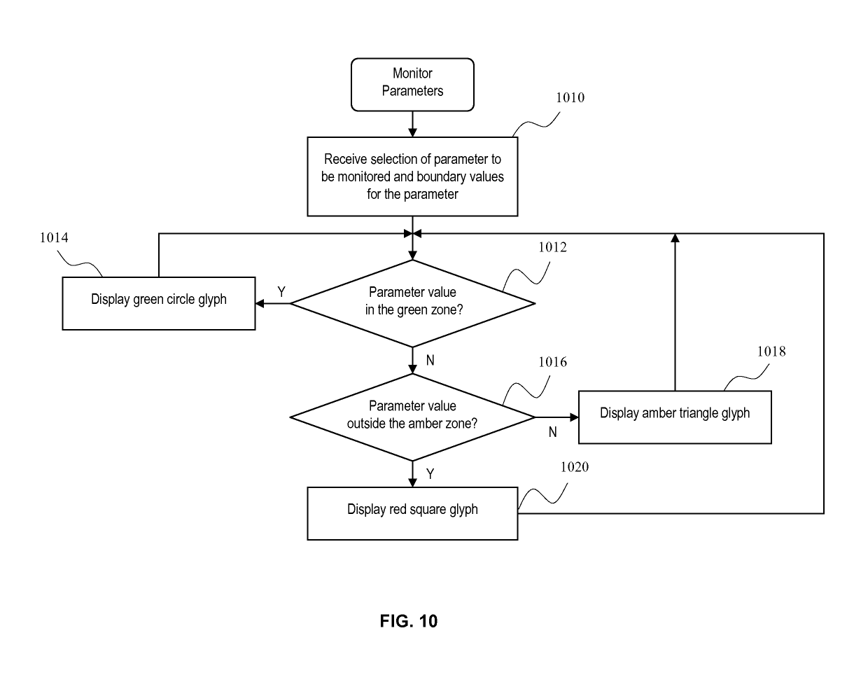

FIG. 10 is a flow diagram that illustrates the steps carried out by CAD application 105 to monitor a parameter's compliance with user-set limits. In step 1010, the CAD application 105 receives through GUI 110 (e.g., through the GUI elements shown in FIGS. 2-6) a selection of the parameter to be monitored and the two sets of boundary values for the selected parameter. In steps 1012 and 1016, compliance with the two sets of boundary values is checked. If the value of the selected parameter is in the green zone, i.e., is within both sets of boundary values, a green circle glyph is displayed in the graphics region (step 1014). A green circle is also displayed next to the sensor browser node corresponding to this selected parameter. The green circle glyph is, however, not displayed in the graphics region if the green zone visibility setting for this parameter has been turned OFF. If the value of the selected parameter is in the amber zone, i.e., is outside the first set of boundary values but within the second set of boundary values, an amber triangle glyph is displayed in the graphics region (step 1018). An amber triangle is also displayed next to the sensor browser node corresponding to this selected parameter. The amber triangle glyph is, however, not displayed in the graphics region if the amber zone visibility setting for this parameter has been turned OFF. If the value of the selected parameter is in the red zone, i.e., is outside both the first and second sets of boundary values, a red square glyph is displayed in the graphics region (step 1020). A red square is also displayed next to the sensor browser node corresponding to this selected parameter. The red square glyph is, however, not displayed in the graphics region if the red zone visibility setting for this parameter has been turned OFF.

In an alternative embodiment of the present invention, multiple green zones are set up for a parameter, and the user is notified with a red symbol if the value for the parameter is not within one of the green zones.

While the foregoing is directed to embodiments of the present invention, other and further embodiments of the invention may be devised without departing from the basic scope thereof, and the scope thereof is determined by the claims that follow.

What is claimed is:

1. A method of monitoring parameters of a computer-aided design (CAD) model and automatically notifying a user through a graphical user interface (GUI) that a parameter has been violated, comprising the steps of:
receiving inputs that specify a parameter to be monitored and at least one boundary value for said parameter;
comparing the value of said parameter with said at least one boundary value as changes are made to the CAD model; and
notifying the user through the GUI when the comparison result indicates that the boundary value has been violated.

2. The method according to claim 1, wherein the user is notified using different symbols.

3. The method according to claim 2, wherein the different symbols are color-coded.

4. The method according to claim 1, wherein the value of said parameter is compared against a first boundary value and a second boundary value, and the user is notified through the GUI with a first symbol if the value of said parameter is between the first and second boundary values and with a second symbol if the value of said parameter is greater than the second value.

5. The method according to claim 4, wherein the first symbol is displayed with a first color and the second symbol is displayed with a second color.

6. The method according to claim 1, wherein the value of said parameter is compared against a first boundary value and a second boundary value, and the user is notified through the GUI with a first symbol if the value of said parameter is between the first and second boundary values and with a second symbol if the value of said parameter is less than the second value.

7. The method according to claim 6, wherein the first symbol is displayed with a first color and the second symbol is displayed with a second color.

8. The method according to claim 1, wherein the parameter to be monitored includes a distance between two surfaces.

9. The method according to claim 8, further comprising the step of computing the distance between two surfaces as changes are made to the CAD model.

10. The method according to claim 1, further comprising the steps of:
displaying a graphic on the GUI corresponding to said parameter;
monitoring the cursor position of a pointing device on the GUI; and
displaying the value of said parameter when the cursor position of the pointing device is within a predetermined proximity to said graphic.

11. A computer-readable medium comprising instructions for causing a computing device to carry out the steps of:
displaying a graphical user interface (GUI) and receiving inputs through the GUI that specify a parameter to be monitored and at least one boundary value for said parameter;
computing the value of said parameter as changes are made to the CAD model;
comparing the value of said parameter with said at least one boundary value; and
notifying the user through the GUI when the comparison result indicates that the boundary value has been violated.

12. The computer-readable medium according to claim 11, wherein the GUI includes a panel for displaying said parameter and said at least one boundary value.

13. The computer-readable medium according to claim 11, wherein the value of said parameter is compared against a first boundary value and a second boundary value, and the user is notified through the GUI with a first symbol if the value of said parameter is between the first and second boundary values and with a second symbol if the value of said parameter is greater than the second value.

14. The computer-readable medium according to claim 11, wherein the value of said parameter is compared against a first boundary value and a second boundary value, and the user is notified through the GUI with a first symbol if the value of said parameter is between the first and second boundary values and with a second symbol if the value of said parameter is less than the second value.

15. The computer-readable medium according to claim 11, wherein the parameter to be monitored includes at least one of length, angle, diameter, perimeter, area, volume, mass, and a distance between two surfaces.

16. A method of interacting with a computer-aided design (CAD) program through a graphical user interface (GUI) that includes a CAD model, comprising the steps of:
specifying a parameter to be monitored and at least one upper boundary value and one lower boundary value for said parameter through the GUI;
making changes to the CAD model through the GUI; and
receiving a notification through the GUI when the value of said parameter is greater than or equal to the upper boundary value or less than or equal to the lower boundary value.

17. The method according to claim 16, wherein a first upper boundary value and a second upper boundary value are specified through the GUI, and the notification includes a first symbol if the value of said parameter is between the first and second upper boundary values and a second symbol if the value of said parameter is greater than the second upper boundary value.

18. The method according to claim 16, wherein a first lower boundary value and a second lower boundary value are specified through the GUI, and the notification includes a first symbol if the value of said parameter is between the first and second lower boundary values and a second symbol if the value of said parameter is less than the second lower boundary value.

19. The method according to claim 16, wherein the step of specifying includes the steps of positioning the cursor of a pointing device on top of a feature on the CAD model so that the feature becomes highlighted and clicking on an input button of the pointing device to select the highlighted feature.

20. The method according to claim 16, further comprising the steps of positioning the cursor of a pointing device on top of a graphic corresponding to said parameter, pressing an input button of the pointing device while having the cursor positioned on top of said graphic, dragging the cursor to a new position while having the input button of the pointing device pressed, and releasing the input button of the pointing device to reposition said graphic at the new position.
